(19) United States
(12) Patent Application Publication
(10) Pub. No.: US 2026/0081662 A1
(43) Pub. Date: Mar. 19, 2026

(54) CSI REPORT WITH CQI VALUES

(71) Applicant: Lenovo (Singapore) Pte. Ltd., Singapore (SG)

(72) Inventors: Ahmed Hindy, Aurora, IL (US); Vijay Nangia, Woodridge, IL (US)

(21) Appl. No.: 19/110,011

(22) PCT Filed: Sep. 18, 2023
(86) PCT No.: PCT/IB2023/059251

§ 371 Date: Mar. 7, 2025

Related U.S. Application Data
(60) Provisional application No. 63/407,527, filed on Sep. 16, 2022.

(51) Int. Cl. H04B 7/06

(52) U.S. Cl. CPC H04B 7/0626; H04B 7/0632; H04B 7/0639

(57) ABSTRACT

Various aspects of the present disclosure relate to reporting Channel State Information (CSI) feedback with Channel Quality Indicator (CQI) values. A UE may be configured to receive a CSI reporting setting and to receive a set of channel measurement reference signals comprising at least one non-zero power (NZP) CSI reference signal (CSI-RS) resource. The UE may be configured to generate CSI feedback report in accordance with the CSI reporting setting and to transmit the CSI feedback report over a physical uplink channel, the CSI feedback report comprising a plurality of CSI report segments and a plurality of CQI values associated with the plurality of CSI report segments.

### TECHNICAL FIELD

The present disclosure relates to wireless communications, and more specifically to reporting Channel State Information (CSI) feedback with Channel Quality Indicator (CQI) values.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

In certain wireless communications networks, CSI feedback is reported by the UE to the network, where the CSI feedback can take multiple forms based on the CSI feedback report size, time and frequency granularity, or other CSI reporting settings.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include UE receiving a CSI reporting setting and receiving a set of channel measurement reference signals comprising at least one non-zero power (NZP) CSI reference signal (CSI-RS) resource. The method and apparatuses described herein may further include the UE generating CSI feedback report comprising a plurality of CSI report segments in accordance with the CSI reporting setting and transmitting the CSI feedback report over a physical uplink channel comprising a plurality of CQI values associated with the plurality of CSI report segments.

Some implementations of the method and apparatuses described herein may further include a network node (e.g., a base station and/or Radio Access Network (RAN) entity) transmitting a CSI reporting setting and transmitting a set of channel measurement reference signals comprising at least one NZP CSI-RS resource. The method and apparatuses described herein may further include the network node receiving a CSI feedback report over a physical uplink channel, the CSI feedback report comprising a plurality of CQI values associated with the plurality of CSI report segments in accordance with the CSI reporting setting, wherein at least one CQI value is associated with each CSI report segment.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of an aperiodic trigger state defining a list of CSI reporting settings, in accordance with aspects of the present disclosure.

FIG. 4A illustrates an example of an Abstract Syntax Notation One (ASN.1) structure of an aperiodic trigger state that indicates the resource set and Quasi-Co-Location (QCL) information, in accordance with aspects of the present disclosure.

FIG. 4B illustrates an example of an ASN.1 structure of a CSI resource configuration associated with the aperiodic trigger state of FIG. 4A, in accordance with aspects of the present disclosure.

FIG. 5A illustrates an example of an ASN.1 structure of a Radio Resource Control (RRC) configuration for NZP CSI-RS resources, in accordance with aspects of the present disclosure.

FIG. 5B illustrates an example of an ASN.1 structure of an RRC configuration for CSI for Interference Measurement (CSI-IM) resources, in accordance with aspects of the present disclosure.

FIG. 6A illustrates an example of CSI report generation, in accordance with aspects of the present disclosure.

FIG. 6B illustrates an example of partial CSI omission and reordering for Physical Uplink Shared Channel (PUSCH) based CSI, in accordance with aspects of the present disclosure.

FIG. 7 illustrates an example of a user equipment (UE) 700, in accordance with aspects of the present disclosure;

FIG. 8 illustrates an example of a processor 800, in accordance with aspects of the present disclosure.

FIG. 9 illustrates an example of a network equipment (NE) 900, in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

Generally, the present disclosure describes systems, methods, and apparatuses for reporting CSI feedback with CQI values. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In wireless communications networks, CSI feedback is reported by the UE to the network, where the CSI feedback can take multiple forms based on the CSI feedback report size, time and frequency granularity, or other CSI reporting settings.

For CSI reporting in 3GPP NR Release 16 specification (Rel-16), two types of codebooks are defined. The NR Type-I codebook uses multiple predefined matrices from which a selection is made by User Equipment (UE) report and/or RRC Configuration. In contrast, the NR Type-II codebook is not based on a predefined table, but it is based on a specifically designed mathematical formula with a several parameters. The parameters in the formula are determined by RRC Configuration and/or UE report. The NR Type-II codebook is based on a more detailed CSI report and supports Multi-User Multiple-Input, Multiple-Output (MU-MIMO) communication.

In NR Rel-16, high-resolution CSI feedback report (i.e., Type-II) was specified, where the frequency granularity of the CSI feedback can be indirectly parametrized. For the 3GPP NR Rel-16 Type-II codebook with high resolution, the number of Precoder Matrix Indicator (PMI) bits fed back from the UE in the next-generation node-B (gNB) via Uplink Control Information (UCI) can be very large (>1000 bits at large bandwidth), even for a single-point transmission. The purpose of multi-panel transmission is to improve the spectral efficiency, as well as the reliability and robustness of the connection in different scenarios, and it covers both ideal and nonideal backhaul. For increasing the reliability using multi-panel transmission, ultra-reliable low-latency communication (URLLC) under multi-panel transmission was agreed, where the UE can be served by multiple Transmit-Receive Points (TRPs) forming a coordination cluster, possibly connected to a central processing unit.

In addition, CSI feedback enhancements corresponding to scenarios in which the UE speed is relatively high are being studied. While one proposal is to report multiple CSI reports, each including Rank Indicator (RI) and/or PMI and/or CQI with lower periodicity, i.e., more frequent reporting, to account for the faster channel variations at high speed, a drawback to this proposal is that larger CSI feedback overhead and higher complexity at the UE to report/compute the multiple CSI reports. While another proposal is to report a single CQI value corresponding to a time interval that is equivalent to the legacy CSI reporting periodicity values, a drawback to this proposal is that a single CQI value may fail to capture the channel variations within a single CSI reporting periodicity value.

In order to accommodate such high-speed scenarios while maintaining similar quality of service, a modified CSI framework, including measurement and reporting, are needed. At high speed, the channel coherence time is expected to fall below conventional CSI reporting periodicity values, and hence the channel quality may vary within one CSI reporting interval. Hence, enhancements to CQI format may be needed. CQI enhancements are proposed for CSI framework under high speed. The proposed solutions comprise the following:

According to a first solution, multiple CQI values are fed back within a CSI report, with a reference CQI value reported with high resolution, e.g., subband (SB) format, and subsequent CQI values reported with lower resolution, e.g., wideband (WB) format.

According to a second solution, the UE reports multiple CQI values with a lower periodicity value, i.e., more frequent reporting, compared with PMI/RI reporting periodicity.

According to a third solution, only two CQI values are fed back within a CSI report, with a configured (and/or reported and/or indicated) extrapolation method to infer the channel quality in intervals other than the two reference intervals corresponding to the two CQI values.

Aspects of the present disclosure are described in the context of a wireless communications system.

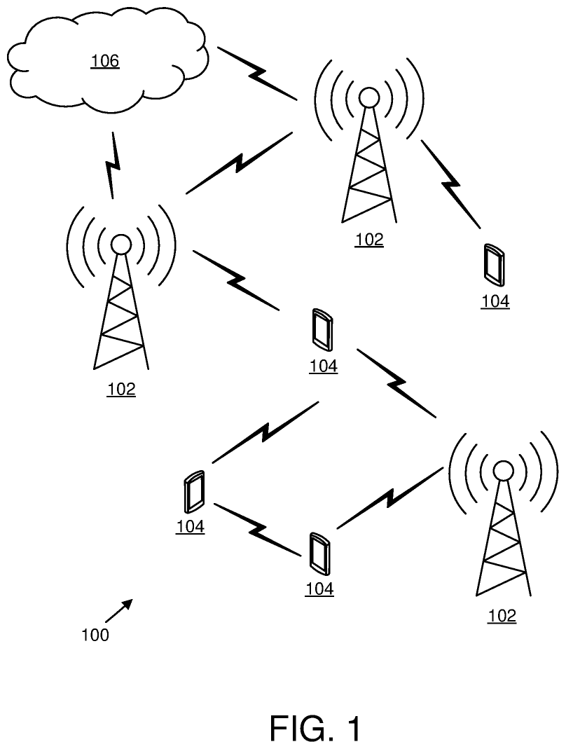

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

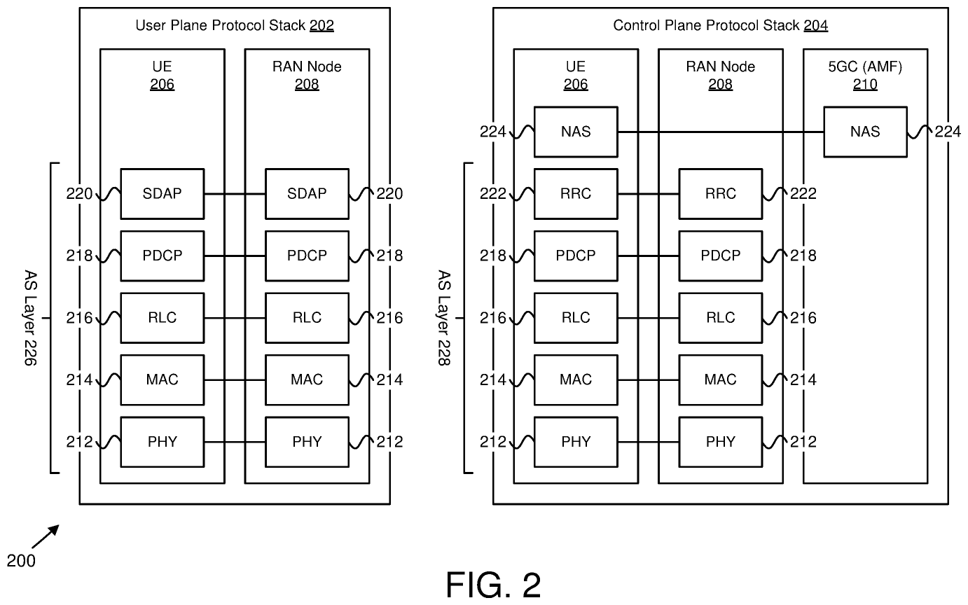

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

Regarding the 3GPP NR Release 15 (Rel-15) Type-II Codebook, it is assumed that the gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂ CSI-RS ports are utilized to enable DL channel estimation with high resolution for NR Rel-15 Type-II codebook. Further details on NR codebook types can be found in 3GPP Technical Specification (TS) 38.214.

In order to reduce the UL feedback overhead, a Discrete Fourier Transform (DFT)-based CSI compression of the spatial domain (SD) is applied to L dimensions per polarization, where L<N₁N₂. In the following, the indices of the 2L dimensions are referred as the SD basis indices. The magnitude and phase values of the linear combination coefficients for each subband are fed back to the gNB as part of the CSI report. The 2N₁N₂×N₃ codebook per transmission layer takes on the form:

$$W = {W}_{1} {W}_{2}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{2} - 1 )}{{O}_{1} {N}_{1}}} {u}_{m}\end{matrix} ]}^{T}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix}$$

$${l}_{i} = {O}_{1} {n}_{1}^{( i )} + {q}_{1} , 0 \leq {n}_{1}^{( i )} < {N}_{1} 0 \leq {q}_{1} < {O}_{1}$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. Note that O₁, O₂ oversampling factors are assumed for the 2D DFT matrix from which matrix B is drawn.

Note that the matrix W₁ is common across all transmission layers. The matrix W₂ is a 2L×N₃ matrix, where the i^{th} column corresponds to the linear combination coefficients of the 2L beams in the i^{th} subband. Only the indices of the L selected columns of B are reported, along with the oversampling index taking on O₁O₂ values. Note that W₂ are independent for different transmission layers.

Regarding 3GPP NR Rel-15, for Type-II Port Selection (PS) codebook, only K (where K≤2N₁N₂) beamformed CSI-RS ports are utilized in DL transmission, in order to reduce complexity. The K×N₃ codebook matrix per transmission layer takes on the form:

$$W = {W}_{1}^{PS} {W}_{2}$$

Here, the matrices W₂ follow the same structure as the conventional NR Rel-15 Type-II Codebook and are transmission layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] , and E is a \frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

$$where {e}_{i}^{( K )}$$

is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The matrix W₁ is common across all transmission layers.

For K=16, L=4 and d_{PS}=1, the 8 possible realizations of E corresponding to m_{PS}={0,1, . . . ,7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{P}s=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for Rank Indicator (RI)=1,2, wherein a phase coupling value is reported for each subband, i.e., W_{2,1} is 2×N₃, with the first row equal to [1, 1, . . . , 1] and the second row equal to

$$[ {e}^{j 2 π {∅}_{0}} , … , {e}^{j 2 π {∅}_{{N}_{3} - 1}} ] .$$

Under specific configurations, φ₀=φ₁ . . . =φ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Rel-16 Type-II Codebook, it is assumed that the gNB is equipped with a 2D antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel-16 Type-II codebook. In order to reduce the UL feedback overhead, a DFT-based CSI compression of the SD is applied to L dimensions per polarization, where L<N₁N₂. Similarly, additional compression in the Frequency Domain (FD) is applied, where each beam of the FD precoding vectors is transformed using an inverse DFT matrix to the delay domain, and the magnitude and phase values of a subset of the delay-domain coefficients are selected and fed back to the gNB as part of the CSI report.

The 2N₁N₂×N₃ codebook per transmission layer takes on the form:

$$W = {W}_{1} {\tilde{W}}_{2 , l} {W}_{f}^{H}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation, and the superscript ^{H} denotes a matrix Hermitian, i.e., conjugate transposition operator. Note that O₁, O₂ oversampling factors are assumed for the 2D DFT matrix from which matrix B is drawn. Note that W₁ is common across all transmission layers. In various embodiments, the above parameters comply with 3GPP TS 38.214 definitions and procedures.

The matrix W_{f} is an N₃×M matrix (where M<N₃) with columns selected from a critically-sampled size-N₃ DFT matrix, as follows:

$${W}_{f} = [ {f}_{{k}_{0}} {f}_{{k}_{1}} … {f}_{{k}_{M ′ - 1}} ] , 0 \leq {k}_{i} \leq {N}_{3} - 1$$

$${f}_{k} = {[ 1 {e}^{- j \frac{2 π k}{{N}_{3}}} … {e}^{- j \frac{2 π k ( {N}_{3} - 1 )}{{N}_{3}}} ]}^{T}$$

Only the indices of the L selected columns of B are reported, along with the oversampling index taking on O₁O₂ values. Similarly, for W_{f}, only the indices of the M selected columns out of the predefined size-N₃ DFT matrix are reported. In the sequel the indices of the M dimensions are referred as the selected FD basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independently for different transmission layers.

Amplitude (i.e., magnitude) and phase values of an approximately f fraction of the 2LM available coefficients are reported to the gNB (β<1) as part of the CSI report. Note that coefficients with zero magnitude are indicated via a per-transmission layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of [2βLM]−1 coefficients (along with the indices of selected L, M DFT vectors) are reported per transmission layer, leading to significant reduction in CSI report size, compared with reporting 2N₁N₂×N₃−1 coefficients' information of a theoretical design.

Regarding 3GPP NR Rel-16, for Type-II PS codebook, only K beamformed CSI-RS ports are utilized in DL transmission (where K≤2N₁N₂), in order to reduce complexity. The K×N₃ codebook matrix per transmission layer takes on the form:

$$W = {W}_{1}^{PS} {\tilde{W}}_{2} {W}_{f}^{H}$$

where the superscript ^{H} denotes a matrix Hermitian, i.e., conjugate transposition operator.

Here, \tilde{W}₂ and W_{f} follow the same structure as the conventional NR Rel-16 Type-II Codebook, described above, where both are transmission layer specific. The matrix W₁^{PS} is a K×2L block-diagonal matrix with the same structure as that in the NR Rel-15 Type-II PS Codebook, described above.

Regarding codebook reporting, the CSI codebook report may be partitioned into two parts based on the priority of information reported. Each part is encoded separately. Note that Part 1 of the codebook report (i.e., CSI report Part 1) may possibly have a higher code rate. Below is listed the parameters for NR Rel-16 Type-II codebook only. More details can be found in 3GPP TS 38.214, Sections 5.2.3 and 5.2.4.

Regarding the contents of the CSI report, the CSI report Part 1 comprises a rank indicator (RI), plus a Channel Quality Indicator (CQI), plus the total number of coefficients (i.e., represented using a single value). The CSI report Part 2 comprises a SD basis indicator, plus a FD basis indicator per transmission layer, plus a bitmap per transmission layer, plus coefficient amplitude information per transmission layer, plus coefficient phase information per transmission layer, plus a strongest coefficient indicator per transmission layer.

Furthermore, the CSI report Part 2 can be decomposed into sub-parts each with different priority (higher priority information listed first). Such partitioning is required to allow dynamic reporting size for codebook based on available resources in the uplink phase. More details can be found in 3GPP TS 38.214, Section 5.2.3.

Also Type-II codebook is based on aperiodic CSI reporting, and only reported in PUSCH via Downlink Control Information (DCI) triggering (one exception). Type-I codebook can be based on periodic CSI reporting (e.g., Physical Uplink Control Channel (PUCCH)) or semi-persistent CSI reporting (e.g., PUSCH or PUCCH) or aperiodic reporting (e.g., PUSCH).

Regarding priority reporting for the CSI report Part 2, note that multiple (i.e., up to N_{Rep}) CSI reports may be transmitted, whose priority are shown in Table 1, below:

TABLE 1
Priority Reporting Levels for Part 2 CSI Reports

Priority 0:
For CSI reports 1 to N_{Rep}, Group 0 CSI for CSI reports configured as ‘typeII-r16’ or ‘typeII-
PortSelection-r16’; Part 2 wideband CSI for CSI reports configured otherwise
Priority 1:
Group 1 CSI for CSI report 1, if configured as ‘typeII-r16’ or ‘typeII-PortSelection-r16’; Part 2
subband CSI of even subbands for CSI report 1, if configured otherwise
Priority 2:
Group 2 CSI for CSI report 1, if configured as ‘typeII-r16’ or ‘typeII-PortSelection-r16’; Part 2
subband CSI of odd subbands for CSI report 1, if configured otherwise
Priority 3:
Group 1 CSI for CSI report 2, if configured as ‘typeII-r16’ or ‘typeII-PortSelection-r16’; Part 2
subband CSI of even subbands for CSI report 2, if configured otherwise
Priority 4:
Group 2 CSI for CSI report 2, if configured as ‘typeII-r16’ or ‘typeII-PortSelection-r16’. Part 2
subband CSI of odd subbands for CSI report 2, if configured otherwise
.
.
.
Priority 2N_{Rep} − 1:
Group 1 CSI for CSI report N_{Rep}, if configured as ‘typeII-r16’ or ‘typeII-PortSelection-r16’;
Part 2 subband CSI of even subbands for CSI report N_{Rep}, if configured otherwise
Priority 2N_{Rep}:
Group 2 CSI for CSI report N_{Rep}, if configured as ‘typeII-r16’ or ‘typeII-PortSelection-r16’;
Part 2 subband CSI of odd subbands for CSI report N_{Rep}, if configured otherwise

Note that the priority of the N_{Rep} CSI reports are based on the following: 1) A CSI report corresponding to one CSI reporting configuration for one cell may have higher priority compared with another CSI report corresponding to one other CSI reporting configuration for the same cell; 2) CSI reports intended to one cell may have higher priority compared with other CSI reports intended to another cell; 3) CSI reports may have higher priority based on the CSI report content, e.g., CSI reports carrying Layer-1 Reference Signal Received Power (L1-RSRP) information have higher priority; and 4) CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority

$${Pri}_{iSCI} ( y , k , c , s ) = 2 \cdot {N}_{cells} \cdot {M}_{s} \cdot y + {N}_{cells} \cdot {M}_{s} \cdot k + {M}_{s} \cdot c + s$$

where s represents the CSI reporting configuration index; Ms represents the maximum number of CSI reporting configurations; c represents Cell index, Ncells represents the number of serving cells; k has a value of 0 for CSI reports carrying L1-RSRP or Layer-1 Signal to Interference and Noise Ratio (L1-SINR), and a value of 1 otherwise; and y has a value of 0 for aperiodic (AP) reports, a value of 1 for semi-persistent (SP) reports on PUSCH, a value of 2 for semi-persistent (SP) reports on PUCCH, and a value of 3 for periodic reports.

Regarding Triggering aperiodic CSI reporting on PUSCH, the UE needs to report the needed CSI information for the network using the CSI framework in NR Release 15. The triggering mechanism between a report setting and a resource setting can be summarized in Table 2 below:

TABLE 2
Triggering mechanism between a report
setting and a resource setting

| | | Periodic CSI | SP CSI | AP CSI |
|---|---|---|---|---|
| | | Reporting | Reporting | Reporting |
| Time | Periodic | RRC | MAC CE | DCI |
| Domain | CSI-RS | configured | (PUCCH) | |
| Behavior of | | | DCI | |
| Resource | | | (PUSCH) | |
| Setting | SP CSI- | Not | MAC CE | DCI |
| | RS | Supported | (PUCCH) | |
| | | | DCI | |
| | | | (PUSCH) | |
| | AP | Not | Not | DCI |
| | CSI-RS | Supported | Supported | |

Moreover, all associated Resource Settings for a CSI Report Setting need to have same time domain behavior. Periodic CSI-RS resource and/or CSI-IM resource and CSI reports are always assumed to be present and active once configured by RRC. Aperiodic and semi-persistent CSI-RS resources and/or CSI-IM resources and CSI reports need to be explicitly triggered or activated. Aperiodic CSI-RS resources and/or CSI-IM resources and aperiodic CSI reports, the triggering is done jointly by transmitting a DCI Format 0-1. Semi-persistent CSI-RS resources and/or CSI-IM resources and semi-persistent CSI reports are independently activated.

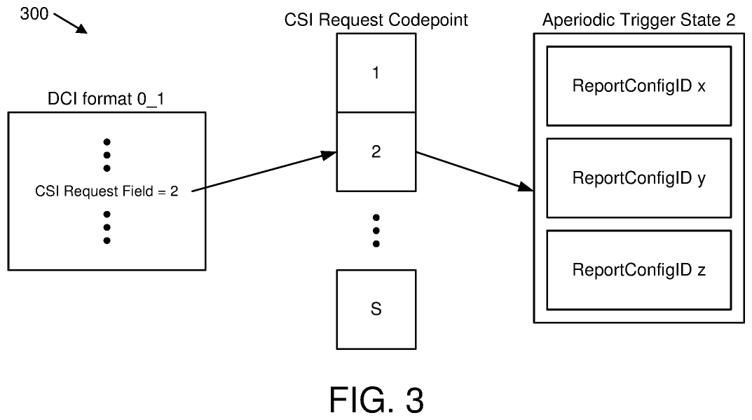

FIG. 3 depicts an exemplary scenario 300 of an aperiodic trigger state defining a list of CSI reporting settings, according to embodiments of the disclosure. For aperiodic CSI-RS resources and/or CSI-IM resources and aperiodic CSI reports, the triggering is done jointly by transmitting a DCI Format 0_1. The DCI Format 0_1 contains a CSI request field (0 to 6 bits). A non-zero request field points to a so-called aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

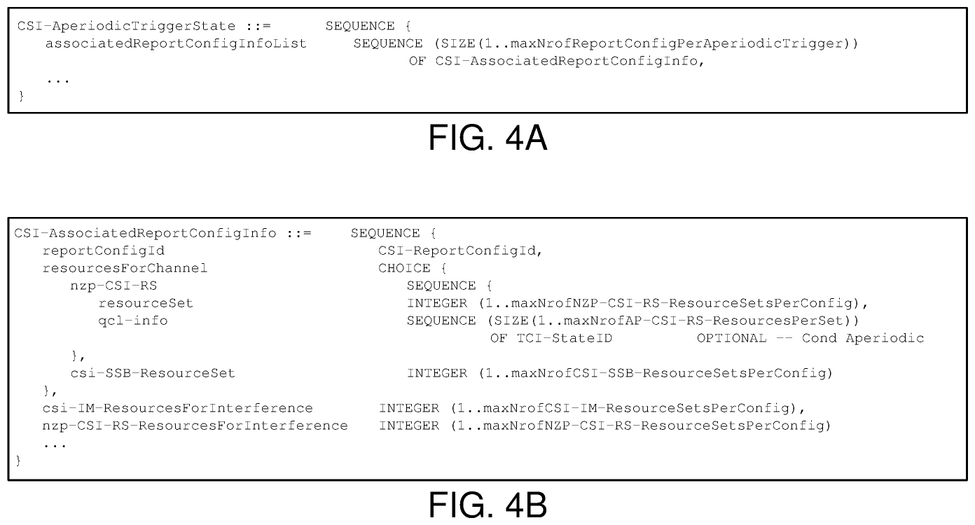

FIG. 4A depicts exemplary ASN.1 structure of an aperiodic trigger state that indicates the resource set and QCL information, according to embodiments of the disclosure.

FIG. 4B depicts exemplary ASN.1 structure of an associated CSI resource configuration, according to embodiments of the disclosure. One or more associated CSI resource configurations may be referenced by the aperiodic trigger state of FIG. 4A.

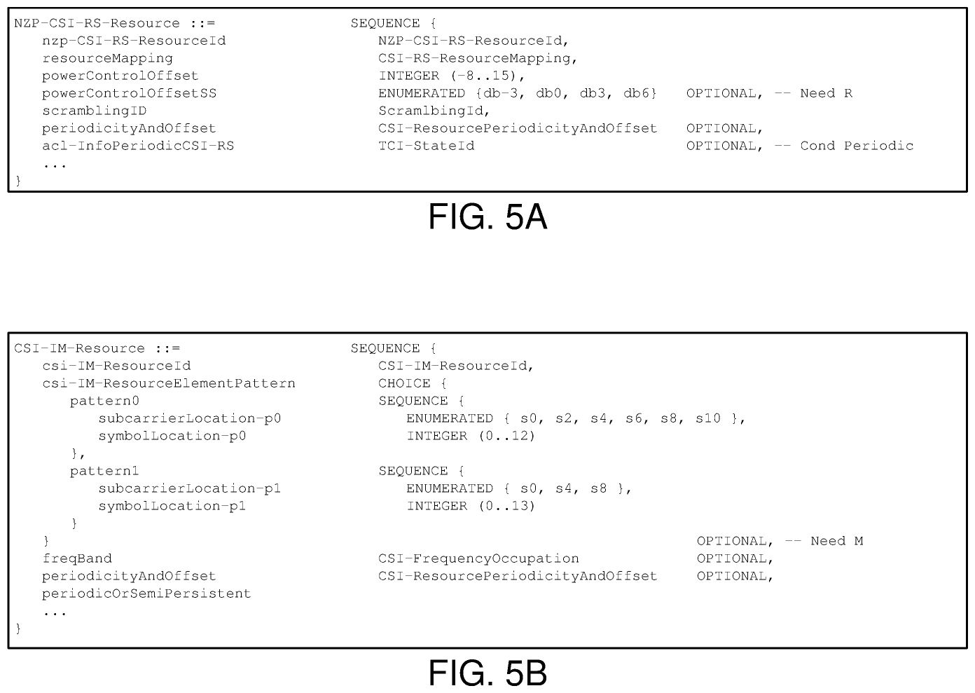

FIG. 5A depicts exemplary ASN.1 structure of an RRC configuration for NZP CSI-RS resources, according to embodiments of the disclosure.

FIG. 5B depicts exemplary ASN.1 structure of an RRC configuration for CSI-IM resources, according to embodiments of the disclosure.

When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for interference management (if used) to use for a given CSI Report Setting are also included in the aperiodic trigger state definition. For aperiodic NZP CSI-RS, the QCL source to use is also configured in the aperiodic trigger state. The UE assumes that the resources used for the computation of the channel and interference can be processed with the same spatial filter, i.e., quasi-co-located with respect to “QCL-TypeD.”

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following: 1) RI (if reported), CRI (if reported) and CQI for the first codeword, and 2) number of non-zero wideband amplitude coefficients per transmission layer for Type-II CSI feedback on PUSCH.

CSI Part 2 has a variable payload size that can be derived from the CSI parameters in CSI Part 1 and contains PMI and the CQI for the second codeword when RI>4.

Table 3 summarizes the types of UL channels used for CSI reporting as a function of the CSI codebook type.

TABLE 3
Uplink channels used for CSI reporting
as a function of the CSI codebook type

| CSI | Periodic CSI | SP CSI | AP CSI |
|---|---|---|---|
| Codebook Type | Reporting | Reporting | Reporting |
| Type-I WB | PUCCH | PUCCH | PUSCH |
| | Format 2, 3, 4 | Format 2 | |
| | | PUSCH | |
| Type-I SB | n/a | PUCCH | PUSCH |
| | | Format 3, 4 | |
| | | PUSCH | |
| Type-II WB | n/a | PUCCH | PUSCH |
| | | Format 3, 4 | |
| | | PUSCH | |
| Type-II SB | n/a | PUSCH | PUSCH |
| Type-II, Part | n/a | PUCCH | n/a |
| 1 only | | Format 3, 4 | |

As an example, if the aperiodic trigger state indicated by DCI format 0_1 defines 3 report settings x, y, and z, then the aperiodic CSI reporting for CSI part 2 will be ordered.

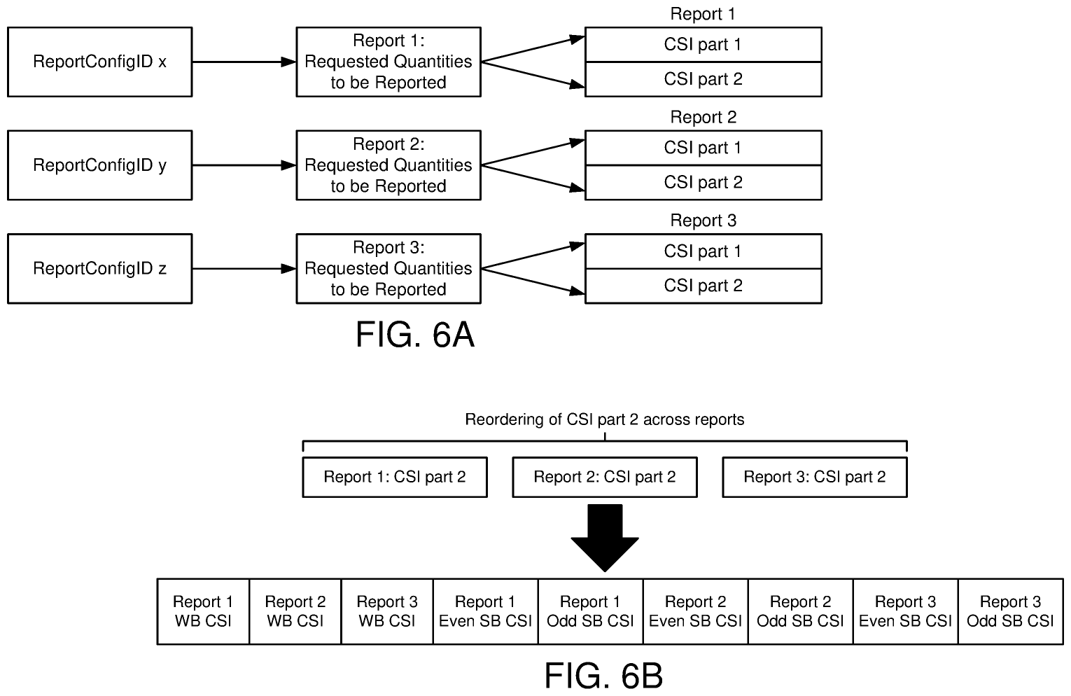

FIG. 6A depicts an exemplary scenario of CSI report generation, according to embodiments of the disclosure. In the depicted example, The DCI format 0_1 depicted report settings for three CSI reporting configurations x, y, and z.

FIG. 6B depicts an exemplary scenario of partial CSI omission and reordering for PUSCH-based CSI, according to embodiments of the disclosure.

CSI reports are prioritized according to: 1) time-domain behavior and physical channel, where more dynamic reports are given precedence over less dynamic reports and PUSCH has precedence over PUCCH; 2) CSI content, where beam reports (i.e., L1-RSRP reporting) has priority over regular CSI reports; 3) the serving cell to which the CSI corresponds (in case of carrier aggregation operation). CSI corresponding to the Primary Cell (PCell) has priority over CSI corresponding to Secondary cells (SCells), and 4) the configuration identifier (i.e., reportConfigID).

A CSI report may comprise a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024 Quadrature amplitude modulation (1024-QAM), whereas the code rate may vary from 30/1024 up to 948/1024. One example of a CQI table for a 4-bit CQI indicator that identifies a possible CQI value with the corresponding modulation order, code rate and efficiency is provided in Table 4, as follows:

TABLE 4
Example of 4-bit CQI table

| | | Code Rate × | |
|---|---|---|---|
| CQI Index | Modulation | 1024 | Efficiency |

| | |
|---|---|
| 0 | Out of Range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16-QAM | 378 | 1.4766 |
| 8 | 16-QAM | 490 | 1.9141 |
| 9 | 16-QAM | 616 | 2.4063 |
| 10 | 64-QAM | 466 | 2.7305 |
| 11 | 64-QAM | 567 | 3.3223 |
| 12 | 64-QAM | 666 | 3.9023 |
| 13 | 64-QAM | 772 | 4.5234 |
| 14 | 64-QAM | 873 | 5.1152 |
| 15 | 64-QAM | 948 | 5.5547 |

A CQI value may be reported in two formats: a wideband format, wherein one CQI value is reported corresponding to each physical downlink shared channel (PDSCH) transport block, and a subband format, wherein one wideband CQI value is reported for the entire transport block, in addition to a set of subband CQI values corresponding to CQI subbands on which the transport block is transmitted. CQI subband sizes are configurable, and depends on the number of Physical Resource Blocks (PRBs) in a bandwidth part (BWP), as shown in Table 5, as follows:

TABLE 5
Configurable subband sizes for a given BWP size

| BWP size (in PRBs) | Subband size (in PRBs) |
|---|---|
| 24-72 | 4, 8 |
| 73-144 | 8, 16 |
| 145-275 | 16, 32 |

If the higher-layer parameter cqi-BitsPerSubband in a CSI reporting setting CSI-ReportConfig is configured (e.g., via RRC signaling), subband CQI values are reported in a full form, i.e., using 4 bits for each subband CQI based on a CQI table, e.g., Table 4. If the higher-layer parameter cqi-BitsPerSubband in CSI-ReportConfig is not configured, for each subband s, a 2-bit subband differential CQI value is reported, defined as: Subband Offset level (s)=Subband CQI index (s)−wideband CQI index.

The mapping from the 2-bit subband differential CQI values to the offset level is shown in Table 6, as follows:

TABLE 6
Mapping subband differential CQI value to offset level

| Subband differential CQI value | Offset level |
|---|---|
| 0 | 0 |
| 1 | 1 |
| 2 | ≥2 |
| 3 | ≤−1 |

Regarding Antenna Panel/Port, Quasi-co-location (QCL), Transmission Configuration Indicator (TCI) state, and Spatial Relation, in some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its transmit (Tx) beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi-co-located (QCL-ed) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial receive (Rx) parameters. Two antenna ports may be QCL-ed with respect to a subset of the large-scale properties and different subset of large-scale properties may be indicated by a QCL Type parameter.

The QCL Type parameter can indicate which channel properties are the same between the two reference signals (e.g., on the two antenna ports). Thus, the reference signals can be linked to each other with respect to what the UE can assume about their channel statistics or QCL properties. For example, parameter qcl-Type may take one of the following values:

$$‘ QCL - TypeA ’ : \{ Doppler shift , Doppler spread , average delay , delay spread \}$$

$$‘ QCL - TypeB ’ : \{ Doppler shift , Doppler spread \}$$

$$‘ QCL - TypeC ’ : \{ Doppler shift , average delay \}$$

$$‘ QCL - TypeD ’ : \{ Spatial Rx parameter \}$$

Spatial Rx parameters may include one or more of: angle of arrival (AoA), Dominant AoA, average AoA, angular spread, Power Angular Spectrum (PAS) of AoA, average angle of departure (AoD), PAS of AoD, transmit/receive channel correlation, transmit/receive beamforming, spatial channel correlation etc.

The values QCL-TypeA, QCL-TypeB, and QCL-TypeC may be applicable for all carrier frequencies, but the value QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD parameter between two reference signals A and B, the reference signal A is considered to be spatially co-located with reference signal B and the UE may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a Transmission Configuration Indication (TCI) state associated with a target transmission can indicate parameters for configuring a QCL relationship between the target transmission (e.g., target Reference Signal (RS) of Demodulation Reference Signal (DM-RS) ports of the target transmission during a transmission occasion) and a source reference signal(s) (e.g., Synchronization Signal Block (SSB), CSI-RS, and/or Sounding Reference Signal (SRS)) with respect to quasi co-location type parameter(s) indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In the following solutions, it is assumed that codebook type used for PMI reporting is flexible (e.g., arbitrary) for use different codebook types, e.g., Type-II Rel-16 codebook, Type-II Release 17 (Rel-17) codebook, Type-II Release 18 (Rel-18) codebook, etc. Several solution sets are described below. According to a possible implementation, one or more elements or features from one or more of the described solution sets may be combined.

According to embodiments of the first solution, the UE is configured with a CSI reporting configuration comprising configuration information corresponding to reference signals used for channel measurement, and configuration information corresponding to CSI reporting feedback for reporting a plurality of CSI report segments. Different implementations of the precoder structure and the corresponding CSI reporting setting are defined for the proposed high-speed CSI codebook. Regarding the CSI reporting configuration, note that one or more of the following implementations may be combined.

In a first implementation of the first solution, the UE is configured with a CSI reporting setting CSI-ReportConfig that is associated with a plurality of PMI values, wherein the plurality of PMI values is reported in a same CSI report. In other words, the UE is configured to report multiple PMI values per CSI report, where the plurality of CSI report segments is the multiple PMI values.

In a second implementation of the first solution, the UE is configured with a CSI reporting setting CSI-ReportConfig that is associated with a plurality of coefficient groups; each coefficient group of said coefficient groups comprises a set of phase coefficients, amplitude coefficients, wherein amplitude coefficients include reference amplitude coefficients and differential amplitude coefficients. In other words, the UE is configured to report multiple coefficient groups (i.e., multiple W₂ matrices) per CSI report, where the plurality of CSI report segments is the multiple coefficient groups.

In one example, four groups G=4, i.e., g=1,2,3,4 of coefficients are reported, wherein the reference amplitude coefficient indicators and the differential amplitude coefficient indicators are indexed as i_{2,3,l,g} and i_{2,4,l,g} for transmission layers l=1, . . . , v are in the form

$${i}_{2 , 3 , l , g} = [ {k}_{l , g , 0}^{( 1 )} {k}_{l , g , 1}^{( 1 )} ]$$

$${i}_{2 , 4 , l , g} = [ {k}_{l , g , 0}^{( 2 )} … {k}_{l , g , {M}_{υ} - 1}^{( 2 )} ]$$

$${i}_{l , g , f} = [ {k}_{l , g , 0 , f}^{( 2 )} … {k}_{l , g , 2 L - 1 , f}^{( 2 )} ]$$

$${k}_{l , g , p}^{( 1 )} ∈ \{ 1 , … , {K}_{1} \}$$

$${k}_{l , g , i , f}^{( 2 )} ∈ \{ 1 , … , {K}_{2} \} .$$

The phase coefficient indicators i_{2,5,l,g} are in the form

$${i}_{2 , 5 , l , g} = [ {c}_{l , g , 0} … {c}_{l , g , {M}_{υ} - 1} ]$$

$${c}_{l , g , f} = [ {c}_{l , g , 0 , f} … {c}_{l , g , L - 1 , f} ]$$

$${c}_{l , g , i , f} ∈ \{ 0 , … , {K}_{3} - 1 \}$$

The bitmap identifying non-zero amplitude coefficients are indicated by a parameter i_{1,7,l,g} as follows

$${i}_{1 , 7 , l , g} = [ {k}_{l , g , 0}^{( 3 )} … {k}_{l , g , {M}_{υ} - 1}^{( 3 )} ]$$

$${k}_{l , g , f}^{( 3 )} = [ {k}_{l , g , 0 , f}^{( 3 )} … {k}_{l , g , 2 L - 1 , f}^{( 3 )} ]$$

$${k}_{l , g , i , f}^{( 3 )} ∈ \{ 0 , 1 \}$$

In a third implementation of the first solution, the UE is configured with a CSI reporting setting that is associated with a plurality of Doppler-domain basis vectors, each Doppler-domain basis vector corresponds to a column of a DFT-based matrix. In other words, the UE is configured to report a Doppler-domain transformation matrix, i.e., comprising multiple Doppler-domain basis vectors per CSI report, where the plurality of CSI report segments is the multiple Doppler-domain basis vectors.

In one example, the precoding matrix that is fed back as PMI in the CSI report corresponding is in a form W₁ \tilde{W}₂(W_{f}⊗W_{d})^{H}, wherein the operator ⊗ corresponds to a Kronecker product, the superscript ^{H} is a conjugate transposition (Hermitian transpose) of a matrix, W₁, \tilde{W}₂, W_{f} correspond to a 2D DFT-based spatial-domain transformation matrix, an amplitude/phase quantized coefficients matrix, and a DFT-based frequency-domain transformation matrix, respectively, whereas W_{d} is a DFT-based time/Doppler-domain basis transformation with D columns, whose columns are selected from a size N₄×N₄ DFT matrix, D≤N₄, whose column r is in a form

$${d}_{r} = {[ 1 {e}^{- j \frac{2 π r}{{N}_{4}}} … {e}^{- j \frac{2 π r ( {N}_{4} - 1 )}{{N}_{4}}} ]}^{T}$$

In a fourth implementation of the first solution, the UE is configured with a plurality of NZP CSI-RS resources for Channel Measurement Resource (CMR). More generally, one or more NZP CSI-RS resources for CMR are associated with multiple channel measurement occasions. In other words, the UE is configured to report multiple CMRs per CSI report, where the plurality of CSI report segments is the multiple CMRs.

In a first example, the UE is configured with an aperiodic NZP CSI-RS resource for CMR, followed by a periodic NZP CSI-RS resource for CMR.

In a second example, the UE is configured with one periodic NZP CSI-RS resource for CMR, wherein each channel measurement is associated with a subset of the transmission occasions of the CMR.

In a third example, the UE is configured with two periodic NZP CSI-RS resources for CMR, wherein each CMR is associated with distinct slot offset value, wherein each channel measurement is associated with a consecutive group of CSI-RS symbols across both CMRs.

In a fifth implementation of the first solution, the UE configured with a codebook type that is set to a Type-II codebook, e.g., TypeII, and a codebook sub-type that is set to a high-speed codebook, e.g., TypeII-HighSpeed-r18, as part of a Rel-18 codebook configuration, e.g., codebookConfig-r18. In other words, the UE is configured to report Rel-18 Type-II high-speed codebook.

According to embodiments of the second solution, the UE is configured with reporting a plurality of CQI values, wherein a number of CQI values corresponds to the number of CSI report segments, e.g., the number of plurality of PMI values, coefficient groups, dimension of the Doppler-domain transformation matrix, the number of plurality of the CMRs, channel measurement occasions, or some combination thereof. Different implementations of CQI reporting are defined, e.g., for the high-speed CSI codebook. Regarding the CSI reporting enhancements, note that of one or more elements or features from one or more of the followings implementations may be combined.

In a first implementation of the second solution, a first CQI value of the plurality of CQI values is reported based on a higher resolution format, and a remainder of CQI values of the plurality of CQI values are reported based on a lower resolution format, compared with that of the first CQI value.

In a first example, a CQI format indicator set to ‘subband’ would correspond to a first CQI value of the plurality of CQI values is reported in a subband format, and a remainder of CQI values of the plurality of CQI values are reported in a wideband format.

In a second example, a new value of a CQI format indicator is used for a scenario in which a first CQI value of the plurality of CQI values is reported in a subband format, and a remainder of CQI values of the plurality of CQI values are reported in a wideband format. For instance, a ‘subband-wideband’ value for the CQI format indicator is introduced for the aforementioned case.

In a third example, a first CQI value of the plurality of CQI values is reported in a subband format, and a remainder of CQI values of the plurality of CQI values are reported in a wideband format.

In a second implementation of the second solution, a first CQI value of the plurality of CQI values is reported as an absolute value (e.g., in a wideband format), and a remainder of CQI values of the plurality of CQI values are reported based on differential values that are computed based on the first CQI value of the plurality of CQI values.

In one example, a 2-bit sub-band differential CQI is defined as:

$$CQI k offset level ( k ) = CQI k index ( k ) - CQI 1 index , k = 2 , 3 , …$$

The mapping from the 2-bit differential CQI values to the offset level is shown in Table 7, as follows:

TABLE 7
Mapping differential CQI k to offset level

| Sub-band differential CQI value | Offset level |
|---|---|
| 0 | 0 |
| 1 | 1 |
| 2 | ≥2 |
| 3 | ≤−1 |

In a third implementation of the second solution, a CQI super-slot size, corresponding to a group of consecutive slots, is configured based on the number of plurality of PMI values, coefficient groups, dimension of the Doppler-domain transformation matrix, the number of plurality of the CMRs, channel measurement occasions, or some combination thereof. Under this implementation, each CQI value of the plurality of CQI values is associated with a CQI super-slot of the plurality of CQI super-slots.

In a first example, the number of slots in the group of slots, i.e., CQI super-slot size, may be configured by higher-layer signaling (e.g., RRC parameter). Alternatively, the CQI super-slot size may be based on a subcarrier spacing, UE processing capability, UE CSI computation time, or some combination thereof.

In a second example, the CQI super-slot size is set by a rule, based on a total number of slots considered, as shown in Table 8. Note that for some cases, the super-slot size may be configured/selected from two values based on a pre-defined rule on the possible super-slot size.

TABLE 8
Configurable CQI super-slot size

| Time unit (slots) | Super-slot size (slots) |
|---|---|
| 4-7 | 2 |
| 8-16 | 2, 4 |
| 17-32 | 4, 8 |

In a fourth implementation of the second solution, each CQI value of the plurality of CQI values is associated with a given slot. In other words, a specific sequence of slots is associated with the CQI values. In a first example, an index of the slot is of a form kQ+q, wherein Q=1, 2, 5, 10, 20, 40, . . . corresponds to a CSI-RS resource periodicity, channel measurement occasion, precoder calculation occasion, or a combination thereof; wherein k=0, 1, 2, 3, . . . corresponds to an index of the CQI value; and wherein q=0, 1, . . . , Q−1 corresponds to a configured, reported, pre-defined slot offset.

In a fifth implementation of the second solution, a CQI value is reported with a time-domain periodicity that is lower than a time-domain periodicity, e.g., M_{CQI}, corresponding to PMI reporting periodicity, e.g., M_{PMI}. In a first example, a CQI periodicity of M_{CQI}=5 ms is configured, compared with a configured PMI periodicity M_{PMI}=20 ms. In a second example, a report quantity comprising only CQI is supported, i.e., a higher-layer parameter reportQuantity can be set to a value ‘CQI.’

According to embodiments of the third solution, the UE is configured to report at least one CQI value and CQI extrapolation information to enable UE-assisted extrapolation of the CQI values. For example, the network may extrapolate CQI values based on the UE's indication of the CQI slope, rate of change, direction of change, or a combination thereof. Different implementations of CQI extrapolation from reported CQI values are provided below. Considering a setup with a combination of one or more of the following implementations is not precluded.

In a first implementation, one CQI value is reported corresponding to a slot t, or alternatively a time interval [s,s+δ] corresponding to a sequence of consecutive slots. An additional indicator is reported in the CSI report that identifies at least one of: 1) a direction of change of the CQI value for subsequent slots or time intervals, e.g., whether a CQI value corresponding to subsequent slots increases, decreases, or remains unchanged; and/or 2) a magnitude of CQI value change for subsequent slots or time intervals, compared with a first slot or time interval.

In one example, a one-bit indicator in a first part of a CSI report is reported, where the one-bit indicator indicates whether a CQI value is changed for subsequent slots or time intervals compared with the first slot or time interval.

A second indicator in a second part of a CSI report is reported conditioned on the value of the one-bit indicator in the first part of the CSI report, where the second indicator is only reported if the one-bit indicator indicates that the CQI value is changed for subsequent slots or time intervals compared with the first slot or time interval. The second indicator may correspond to a direction of change of the CQI value, or the magnitude of change of the CQI value for subsequent slots/time intervals, or both.

In a second implementation, two CQI values are reported corresponding to a slot t and a slot t+t₀, or alternatively a time interval [s₀,s₀+δ] and a time interval [s₁,s₁+δ], where s₁>s₀+δ. A function corresponding to a temporal variation curve around a first and a second of the two CQI indicators is reported by the UE. In other words, the function describes the extrapolation of CQI values around the two CQI values.

In a first example, the function corresponding to the temporal variation curve can be of a form of a linear variation, i.e., uniform variation, a logarithmic variation, i.e., a variation that is slowing down across subsequent CQI values, or an exponential variation, i.e., a variation that is ramping up across subsequent CQI values. In a second example, the function corresponds to an interpolation function of one or more CQI value within the slots or time intervals within the two CQI value indicators reporting in the CSI report.

In a third implementation, the UE reports multiple CQI values for each are reported for each CSI reporting occasion. In a first example, multiple CQI values are reported for each reported PMI value of the plurality of reported PMI values. In a second example, multiple CQI values are reported for each reported PMI coefficient group of the plurality of reported PMI coefficient groups.

In a third example, multiple CQI values are reported for each dimension of a reported Doppler-domain transformation matrix of the plurality of dimensions of the reported Doppler-domain transformation matrix. In a fourth example, multiple CQI values are reported for each CMR/channel measurement occasion of the plurality of CMRs/channel measurement occasions.

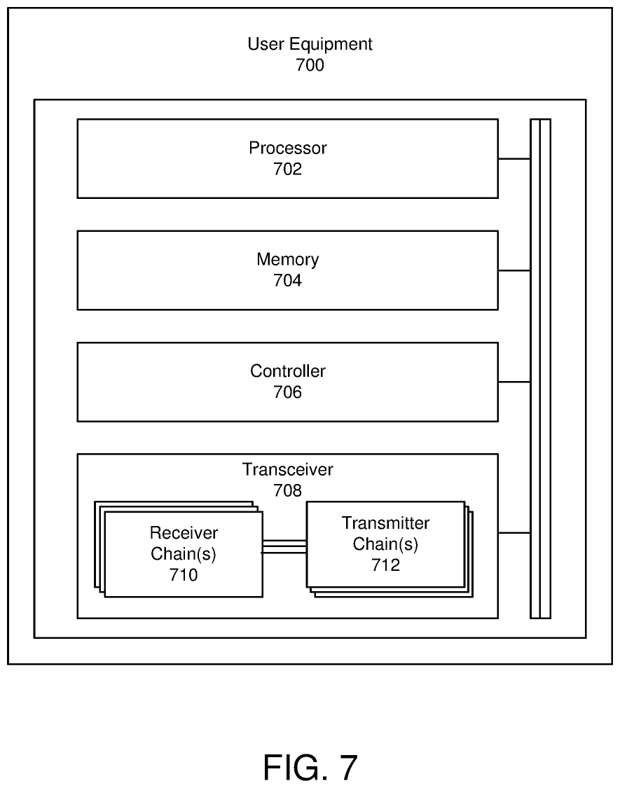

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, a Field Programmable Gate Array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to support a means for receiving a CSI reporting setting and a means for receiving a set of channel measurement reference signals including at least one NZP CSI-RS resource. In certain implementations, the CSI reporting setting includes a codebook type parameter that is set to a New Radio Type-II codebook. In certain implementations, the CSI reporting setting may further include a codebook sub-type parameter that is set to a high-speed codebook.

In some implementations, the CSI reporting setting indicates a CQI slot-group size corresponding to a set of consecutive slots forming a CQI slot group, where a single CQI value is reported for each CQI slot group. In certain implementations, a number of CQI slot groups is based on a number of the plurality of CSI report segments.

In one implementation, the CQI slot-group size is configured via a higher-layer signaling parameter. In other implementations, the CQI slot-group size is based on a value of a subcarrier spacing, a UE processing capability, a UE CSI computation time, or a combination thereof.

The UE 700 may be configured to support a means for generating CSI feedback report in accordance with the CSI reporting setting and a means for transmitting the CSI feedback report over a physical uplink channel, where the CSI feedback report includes a plurality of CSI report segments and a plurality of CQI values associated with the plurality of CSI report segments.

In some implementations, at least one CQI values is associated with each CSI report segment. In some implementations, the plurality of CSI report segments corresponds to a plurality of PMI values.

In some implementations, the plurality of CSI report segments corresponds to a plurality of PMI coefficient groups, where each coefficient group of the plurality of PMI coefficient groups includes a set of phase coefficients and amplitude coefficients. In certain implementations, the set of phase coefficients and amplitude coefficients include at least one reference amplitude coefficient and at least one differential amplitude coefficient.

In some implementations, the plurality of CSI report segments corresponds to a plurality of Doppler-domain basis vectors, each Doppler-domain basis vector corresponding to a column of a DFT-based matrix. In some implementations, plurality of CSI report segments corresponds to a plurality of NZP CSI-RS resources associated with multiple channel measurement occasions.

In some implementations, a single CQI value is reported for each CSI report segment. In certain implementations, a first CQI value corresponding to a first CSI report segment is reported as an absolute value, where a remainder of the plurality of CQI values are reported as a set of differential values based on the first CQI value.

In certain implementations, a first CQI value corresponding to a first CSI report segment is reported based on a higher resolution format, where a remainder of the plurality of CQI values are reported based on a lower resolution format as compared with that of the first CQI value. In one implementation, the higher resolution format corresponds to a subband format, and the lower resolution format corresponds to a wideband format.

In some implementations, each CQI value of the plurality of CQI values is associated with a slot index, where the associated slot index is based on a configured CQI reporting periodicity value, an index of an order of the reported CQI value, and a slot offset corresponding to reporting the CQI value.

In some implementations, the CSI reporting setting indicates a CQI reporting periodicity and a PMI reporting periodicity. In certain implementations, a respective CQI value is reported with a periodicity value that is no larger than a PMI reporting periodicity value.

In some implementations, a first CSI report segment of the plurality of CSI report segments is configured to be reported with a first periodicity value that is different from a second periodicity value corresponding to CSI report segments of the plurality of CSI report segments that are subsequent to the first CSI report segment.

In some implementations, the plurality of CQI values associated with the plurality of CSI report segments consists of two CQI values corresponding to the entirety of the plurality of CSI report segments. In certain implementations, a first CQI value of the two CQI values corresponds to a first CSI report segment of the plurality of the CSI report segments, and a second CQI value of the two CQI values corresponds to a last CSI report segment of the plurality of the CSI report segments.

In certain implementations, the CSI feedback report further includes an indicator corresponding to a slope for a CQI variation within two CQI value reporting occasions corresponding to the two CQI values. In further implementations, the slope indicator includes a direction-of-change value and a magnitude value.

In some implementations, the CSI reporting setting indicates an extrapolation/interpolation function for CQI calculation within two CQI value reporting occasions corresponding to the two CQI values. In certain implementations, the extrapolation/interpolation function is defined for CQI inference between the two CQI value reporting occasions.

In certain implementations, the CSI feedback report includes a selection of the extrapolation/interpolation function from a set of extrapolation/interpolation functions. In further implementations, the set of extrapolation/interpolation functions includes at least one of: a linear function, a logarithmic function, or an exponential function.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the receiving signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

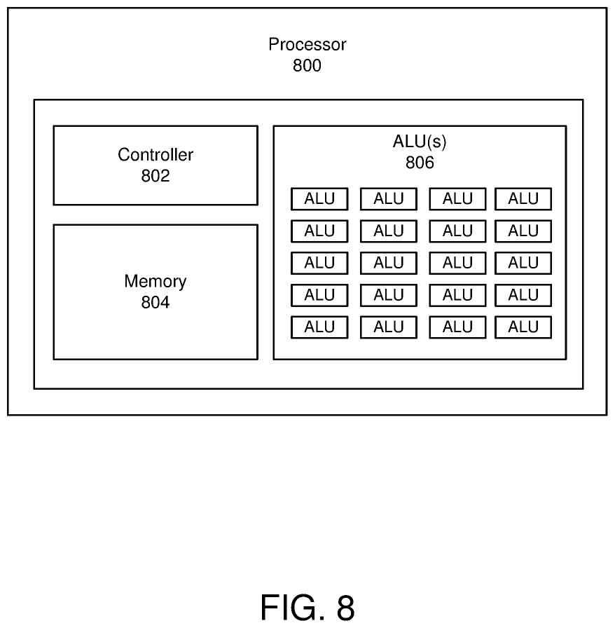

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support a means for receiving a CSI reporting setting and a means for receiving a set of channel measurement reference signals including at least one NZP CSI-RS resource. In certain implementations, the CSI reporting setting includes a codebook type parameter that is set to a New Radio Type-II codebook. In certain implementations, the CSI reporting setting may further include a codebook sub-type parameter that is set to a high-speed codebook.

In some implementations, the CSI reporting setting indicates a CQI slot-group size corresponding to a set of consecutive slots forming a CQI slot group, where a single CQI value is reported for each CQI slot group. In certain implementations, a number of CQI slot groups is based on a number of the plurality of CSI report segments.

In one implementation, the CQI slot-group size is configured via a higher-layer signaling parameter. In other implementations, the CQI slot-group size is based on a value of a subcarrier spacing, a UE processing capability, a UE CSI computation time, or a combination thereof.

The processor 800 may be configured to support a means for generating CSI feedback report in accordance with the CSI reporting setting and a means for transmitting the CSI feedback report over a physical uplink channel, where the CSI feedback report includes a plurality of CSI report segments and a plurality of CQI values associated with the plurality of CSI report segments.

In some implementations, at least one CQI values is associated with each CSI report segment. In some implementations, the plurality of CSI report segments corresponds to a plurality of PMI values.

In some implementations, the plurality of CSI report segments corresponds to a plurality of PMI coefficient groups, where each coefficient group of the plurality of PMI coefficient groups includes a set of phase coefficients and amplitude coefficients. In certain implementations, the set of phase coefficients and amplitude coefficients include at least one reference amplitude coefficient and at least one differential amplitude coefficient.

In some implementations, the plurality of CSI report segments corresponds to a plurality of Doppler-domain basis vectors, each Doppler-domain basis vector corresponding to a column of a DFT-based matrix. In some implementations, plurality of CSI report segments corresponds to a plurality of NZP CSI-RS resources associated with multiple channel measurement occasions.

In some implementations, a single CQI value is reported for each CSI report segment. In certain implementations, a first CQI value corresponding to a first CSI report segment is reported as an absolute value, where a remainder of the plurality of CQI values are reported as a set of differential values based on the first CQI value.

In certain implementations, a first CQI value corresponding to a first CSI report segment is reported based on a higher resolution format, where a remainder of the plurality of CQI values are reported based on a lower resolution format as compared with that of the first CQI value. In one implementation, the higher resolution format corresponds to a subband format, and the lower resolution format corresponds to a wideband format.

In some implementations, each CQI value of the plurality of CQI values is associated with a slot index, where the associated slot index is based on a configured CQI reporting periodicity value, an index of an order of the reported CQI value, and a slot offset corresponding to reporting the CQI value.

In some implementations, the CSI reporting setting indicates a CQI reporting periodicity and a PMI reporting periodicity. In certain implementations, a respective CQI value is reported with a periodicity value that is no larger than a PMI reporting periodicity value.

In some implementations, a first CSI report segment of the plurality of CSI report segments is configured to be reported with a first periodicity value that is different from a second periodicity value corresponding to CSI report segments of the plurality of CSI report segments that are subsequent to the first CSI report segment.

In some implementations, the plurality of CQI values associated with the plurality of CSI report segments consists of two CQI values corresponding to the entirety of the plurality of CSI report segments. In certain implementations, a first CQI value of the two CQI values corresponds to a first CSI report segment of the plurality of the CSI report segments, and a second CQI value of the two CQI values corresponds to a last CSI report segment of the plurality of the CSI report segments.

In certain implementations, the CSI feedback report further includes an indicator corresponding to a slope for a CQI variation within two CQI value reporting occasions corresponding to the two CQI values. In further implementations, the slope indicator includes a direction-of-change value and a magnitude value.

In some implementations, the CSI reporting setting indicates an extrapolation/interpolation function for CQI calculation within two CQI value reporting occasions corresponding to the two CQI values. In certain implementations, the extrapolation/interpolation function is defined for CQI inference between the two CQI value reporting occasions.

In certain implementations, the CSI feedback report includes a selection of the extrapolation/interpolation function from a set of extrapolation/interpolation functions. In further implementations, the set of extrapolation/interpolation functions includes at least one of: a linear function, a logarithmic function, or an exponential function.

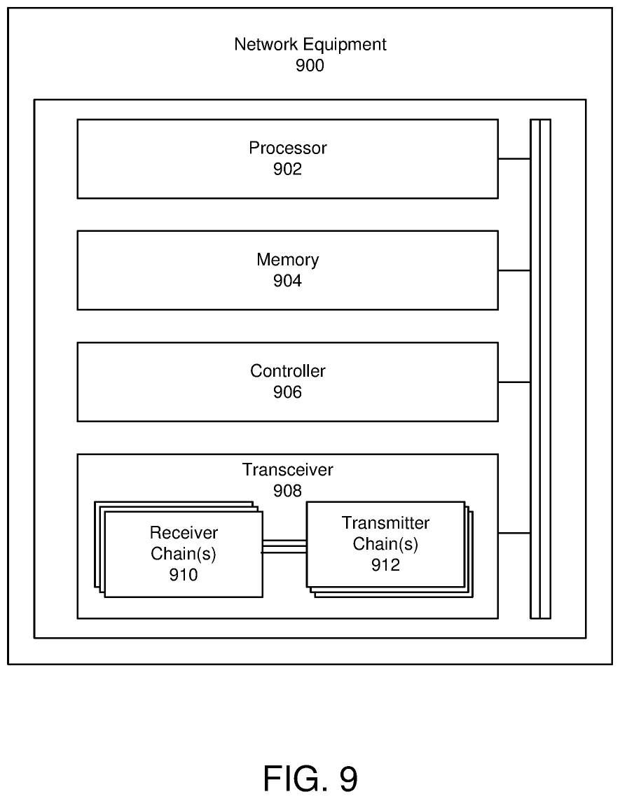

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for transmitting, to a UE, a CSI reporting setting and a means for transmitting a set of channel measurement reference signals including at least one NZP CSI-RS resource.

In some implementations, the CSI reporting setting includes a codebook type parameter that is set to a New Radio Type-II codebook. In some implementations, the CSI reporting setting may further include a codebook sub-type parameter that is set to a high-speed codebook.

In some implementations, the CSI reporting setting indicates a CQI slot-group size corresponding to a set of consecutive slots forming a CQI slot group, where a single CQI value is reported for each CQI slot group. In certain implementations, a number of CQI slot groups is based on a number of the plurality of CSI report segments.

In one implementation, the CQI slot-group size is configured via a higher-layer signaling parameter. In other implementations, the CQI slot-group size is based on a value of a subcarrier spacing, a UE processing capability, a UE CSI computation time, or a combination thereof.

The NE 900 may be configured to support a means for receiving, from the UE, a CSI feedback report over a physical uplink channel, the CSI feedback report including a plurality of CQI values associated with the plurality of CSI report segments in accordance with the CSI reporting setting, where at least one CQI value is associated with each CSI report segment.

In some implementations, at least one CQI value is associated with each CSI report segment. In some implementations, the plurality of CSI report segments corresponds to a plurality of PMI values.

In some implementations, the plurality of CSI report segments corresponds to a plurality of PMI coefficient groups, where each coefficient group of the plurality of PMI coefficient groups includes a set of phase coefficients and amplitude coefficients. In certain implementations, the set of phase coefficients and amplitude coefficients include at least one reference amplitude coefficient and at least one differential amplitude coefficient.

In some implementations, the plurality of CSI report segments corresponds to a plurality of Doppler-domain basis vectors, each Doppler-domain basis vector corresponding to a column of a DFT-based matrix. In some implementations, plurality of CSI report segments corresponds to a plurality of NZP CSI-RS resources associated with multiple channel measurement occasions.

In some implementations, a single CQI value is reported for each CSI report segment. In certain implementations, a first CQI value corresponding to a first CSI report segment is reported as an absolute value, where a remainder of the plurality of CQI values are reported as a set of differential values based on the first CQI value.

In certain implementations, a first CQI value corresponding to a first CSI report segment is reported based on a higher resolution format, where a remainder of the plurality of CQI values are reported based on a lower resolution format as compared with that of the first CQI value. In one implementation, the higher resolution format corresponds to a subband format, and the lower resolution format corresponds to a wideband format.

In some implementations, each CQI value of the plurality of CQI values is associated with a slot index, where the associated slot index is based on a configured CQI reporting periodicity value, an index of an order of the reported CQI value, and a slot offset corresponding to reporting the CQI value.

In some implementations, the CSI reporting setting indicates a CQI reporting periodicity and a PMI reporting periodicity. In certain implementations, a respective CQI value is reported with a periodicity value that is no larger than a PMI reporting periodicity value.

In some implementations, the processor further configures a first CSI report segment of the plurality of CSI report segments to be reported with a first periodicity value that is different from a second periodicity value corresponding to CSI report segments of the plurality of CSI report segments that are subsequent to the first CSI report segment.

In some implementations, the plurality of CQI values associated with the plurality of CSI report segments consists of two CQI values corresponding to the entirety of the plurality of CSI report segments. In certain implementations, a first CQI value of the two CQI values corresponds to a first CSI report segment of the plurality of the CSI report segments, and a second CQI value of the two CQI values corresponds to a last CSI report segment of the plurality of the CSI report segments.

In certain implementations, the CSI feedback report further includes an indicator corresponding to a slope for a CQI variation within two CQI value reporting occasions corresponding to the two CQI values. In further implementations, the slope indicator includes a direction-of-change value and a magnitude value.

In some implementations, the CSI reporting setting indicates an extrapolation/interpolation function for CQI calculation within two CQI value reporting occasions corresponding to the two CQI values. In certain implementations, the extrapolation/interpolation function is defined for CQI inference between the two CQI value reporting occasions.

In certain implementations, the CSI feedback report includes a selection of the extrapolation/interpolation function from a set of extrapolation/interpolation functions. In further implementations, the set of extrapolation/interpolation functions includes at least one of: a linear function, a logarithmic function, or an exponential function.

The controller 906 may manage input and output signals for the NE 900. The controller 906 may also manage peripherals not integrated into the NE 900. In some implementations, the controller 906 may utilize an operating system (OS) such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receiving signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

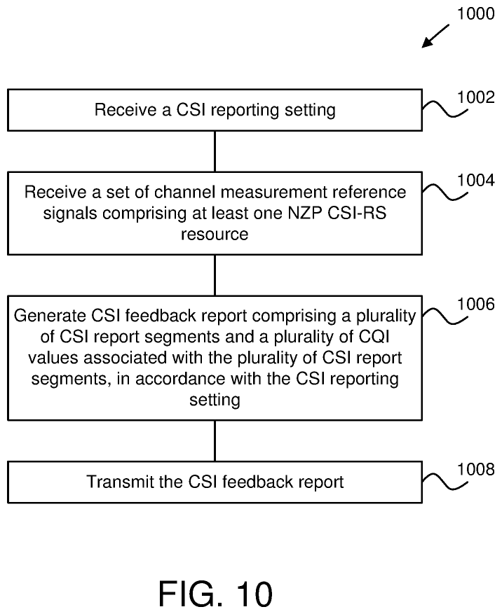

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At Step 1002, the method 1000 may include receiving a CSI reporting setting. The operations of Step 1002 may be performed in accordance with examples as described herein. In some implementations, aspects of the operations of Step 1002 may be performed by a UE as described with reference to FIG. 7.

At Step 1004, the method 1000 may include receiving a set of channel measurement reference signals comprising at least one NZP CSI-RS resource. The operations of Step 1004 may be performed in accordance with examples as described herein. In some implementations, aspects of the operations of Step 1004 may be performed by a UE as described with reference to FIG. 7.

At Step 1006, the method 1000 may include generating CSI feedback report comprising a plurality of CSI report segments and a plurality of CQI values associated with the plurality of CSI report segments, in accordance with the CSI reporting setting. The operations of Step 1006 may be performed in accordance with examples as described herein. In some implementations, aspects of the operations of Step 1006 may be performed a UE as described with reference to FIG. 7.

At Step 1008, the method 1000 may include transmitting the CSI feedback report. The operations of Step 1008 may be performed in accordance with examples as described herein. In some implementations, aspects of the operations of Step 1008 may be performed a UE as described with reference to FIG. 7.

It should be noted that the method 1000 described herein describes one possible implementation, and that the operations and the steps may be rearranged or otherwise modified and that other implementations are possible.

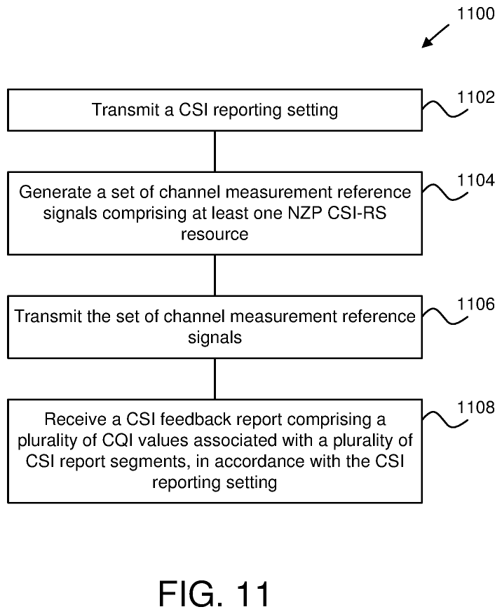

FIG. 11 illustrates a flowchart of a method 1100 in accordance with aspects of the present disclosure. The operations of the method 1100 may be implemented by a NE as described herein. In some implementations, the NE may execute a set of instructions to control the function elements of the NE to perform the described functions.

At Step 1102, the method 1100 may include transmitting a CSI reporting setting. The operations of Step 1102 may be performed in accordance with examples as described herein. In some implementations, aspects of the operations of Step 1102 may be performed by a NE as described with reference to FIG. 9.

At Step 1104, the method 1100 may include generating a set of channel measurement reference signals comprising at least one NZP CSI-RS resource. The operations of Step 1104 may be performed in accordance with examples as described herein. In some implementations, aspects of the operations of Step 1104 may be performed by a NE as described with reference to FIG. 9.

At Step 1106, the method 1100 may include transmitting the set of channel measurement reference signals to a UE. The operations of Step 1106 may be performed in accordance with examples as described herein. In some implementations, aspects of the operations of Step 1106 may be performed a NE as described with reference to FIG. 9.

At Step 1108, the method 1100 may include receiving a CSI feedback report comprising a plurality of CQI values associated with a plurality of CSI report segments in accordance with the CSI reporting setting. The operations of Step 1108 may be performed in accordance with examples as described herein. In some implementations, aspects of the operations of Step 1108 may be performed a NE as described with reference to FIG. 9.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A User Equipment (UE) for wireless communication, comprising:
at least one memory; and
at least one processor coupled with the at least one memory and configured to cause the UE to:
receive a Channel State Information (CSI) reporting setting;
receive a set of channel measurement reference signals comprising at least one non-zero power (NZP) CSI reference signal (CSI-RS) resource;
generate CSI feedback report comprising a plurality of CSI report segments and a plurality of Channel Quality Indicator (CQI) values associated with the plurality of CSI report segments, in accordance with the CSI reporting setting; and
transmit the CSI feedback report.

2. The UE of claim 1, wherein the plurality of CSI report segments corresponds to a plurality of Precoder Matrix Indicator (PMI) values.

3. The UE of claim 1, wherein the plurality of CSI report segments corresponds to a plurality of Precoder Matrix Indicator (PMI) coefficient groups, wherein each coefficient group of the plurality of PMI coefficient groups comprises a set of phase coefficients and amplitude coefficients.

4. The UE of claim 1, wherein the plurality of CSI report segments corresponds to a plurality of Doppler-domain basis vectors, each Doppler-domain basis vector corresponding to a column of a Discrete Fourier Transform (DFT)-based matrix.

5. The UE of claim 1, wherein the CSI reporting setting comprises a codebook type parameter that is set to a New Radio Type-II codebook, wherein the CSI reporting setting comprises a codebook sub-type parameter that is set to a high-speed codebook.

6. The UE of claim 1, wherein a single CQI value is reported for each CSI report segment.

7. The UE of claim 6, wherein a first CQI value corresponding to a first CSI report segment is reported based on a higher resolution format, wherein a remainder of the plurality of CQI values are reported based on a lower resolution format as compared with that of the first CQI value, and wherein the higher resolution format corresponds to a subband format, and wherein the lower resolution format corresponds to a wideband format.

8. The UE of claim 6, wherein a first CQI value corresponding to a first CSI report segment is reported as an absolute value, and wherein a remainder of the plurality of CQI values are reported as a set of differential values based on the first CQI value.

9. The UE of claim 1, wherein the CSI reporting setting indicates a CQI slot-group size corresponding to a set of consecutive slots forming a CQI slot group, wherein a single CQI value is reported for each CQI slot group.

10. The UE of claim 9, wherein a number of CQI slot groups is based on a number of the plurality of CSI report segments, and wherein the CQI slot-group size is one of:
configured via a higher-layer signaling parameter;
based on a value of a subcarrier spacing;
based on a UE processing capability;
based on a UE CSI computation time;
or a combination thereof.

11. The UE of claim 1, wherein each CQI value of the plurality of CQI values is associated with a slot index, wherein the associated slot index is based on a slot offset corresponding to reporting the CQI value.

12. The UE of claim 1, wherein the CSI reporting setting indicates a CQI reporting periodicity and a Precoder Matrix Indicator (PMI) reporting periodicity, and a value of the CQI reporting periodicity is no larger than a value of the PMI reporting periodicity.

13. The UE of claim 1, wherein a first CSI report segment of the plurality of CSI report segments is configured to be reported with a first periodicity value that is different from a second periodicity value corresponding to CSI report segments of the plurality of CSI report segments that are subsequent to the first CSI report segment.

14. The UE of claim 1, wherein a number of the plurality of CQI values associated with the plurality of CSI report segments is equal to two CQI values.

15. The UE of claim 14, wherein a first CQI value of the two CQI values corresponds to a first CSI report segment of the plurality of the CSI report segments, and a second CQI value of the two CQI values corresponds to a last CSI report segment of the plurality of the CSI report segments.

16. The UE of claim 14, wherein the CSI feedback report further comprises an indicator corresponding to a slope for a CQI variation within two CQI value reporting occasions corresponding to the two CQI values, and wherein the indicator comprises a direction-of-change value and a magnitude value.

17. The UE of claim 14, wherein the CSI reporting setting indicates an extrapolation/interpolation function for CQI calculation within two CQI value reporting occasions corresponding to the two CQI values, and wherein the extrapolation/interpolation function is defined for CQI inference between the two CQI value reporting occasions.

18. A method performed by a user equipment (UE), the method comprising:
receiving a Channel State Information (CSI) reporting setting;
receiving a set of channel measurement reference signals comprising at least one non-zero power (NZP) CSI reference signal (CSI-RS) resource;
generating CSI feedback report comprising a plurality of CSI report segments and a plurality of Channel Quality Indicator (CQI) values associated with the plurality of CSI report segments, in accordance with the CSI reporting setting; and
transmitting the CSI feedback report.

19. A base station for wireless communication, comprising:
at least one memory; and
at least one processor coupled with the at least one memory and configured to cause the base station to:
transmit a Channel State Information (CSI) reporting setting;
generate a set of channel measurement reference signals comprising at least one non-zero power (NZP) CSI reference signal (CSI-RS) resource;
transmit the set of channel measurement reference signals to a User Equipment (UE); and
receive a CSI feedback report comprising a plurality of Channel Quality Indicator (CQI) values associated with a plurality of CSI report segments, in accordance with the CSI reporting setting.

20. A method performed by a base station, the method comprising:
transmitting a Channel State Information (CSI) reporting setting;
generating a set of channel measurement reference signals comprising at least one non-zero power (NZP) CSI reference signal (CSI-RS) resource;
transmitting the set of channel measurement reference signals to a User Equipment (UE); and
receiving a CSI feedback report comprising a plurality of Channel Quality Indicator (CQI) values associated with a plurality of CSI report segments, in accordance with the CSI reporting setting.
